(19) United States
(12) Patent Application Publication
(10) Pub. No.: US 2003/0189305 A1
(43) Pub. Date: Oct. 9, 2003

(54) Fluid automatic bicycle transmission

(76) Inventor: Thomas Irvin Mallard, Seattle, WA (US)

Correspondence Address: THOMAS I. MALLARD, 12063 10TH AVE. S., SEATTLE, WA, 98168, US

(21) Appl. No.: 10/117,624

(22) Filed: Apr. 8, 2002

(51) Int. Cl. B62M 1/10

(52) U.S. Cl. 280/216

(57) ABSTRACT

A fluid automatic transmission for bicycles and other human powered vehicles that dynamically regulates torque thus changing mechanical advantage for the rider or engine. Similar in principle to using an automotive torque-converter that is never locked-out, the design is unique in applying that concept to the bicycle drive train.

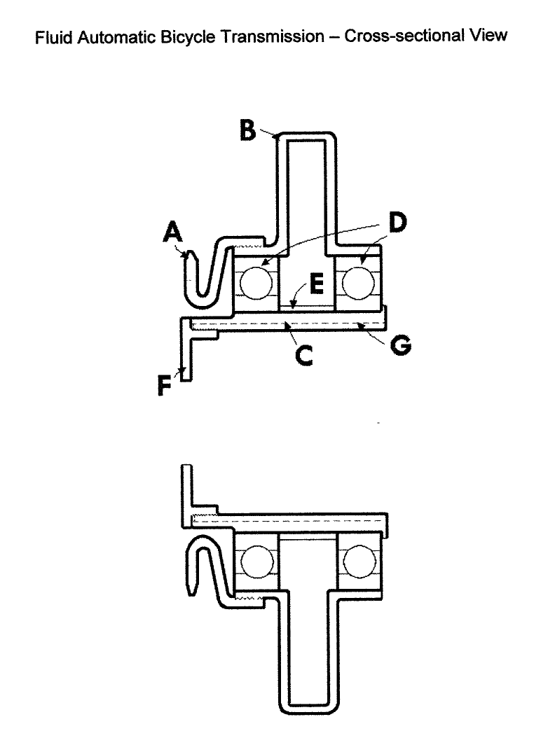

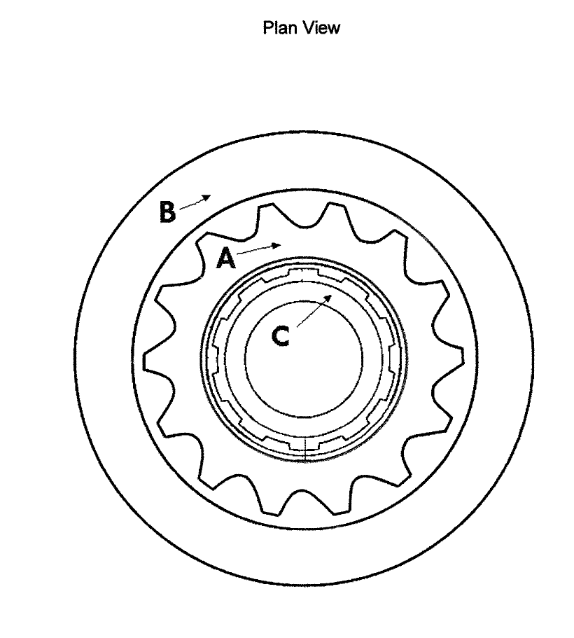

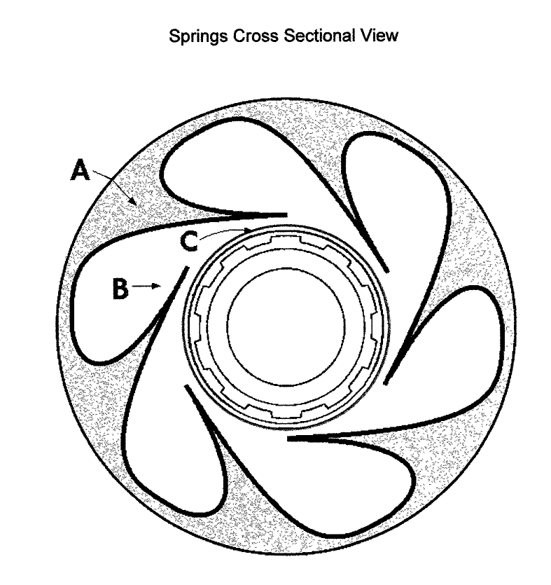

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Classification: Bicycle, 280 Land Vehicles

29 Wheeled

200 . . . Occupant propelled type

210 . . . With propulsion means

236 . . . Reversing and power ratio change

This invention results from a ten year effort to use fluid to transmit power and to change mechanical advantage in a transmission automatically for the rider of human powered vehicles, especially bicycles. This invention is based on mature automotive industry hydraulic and fluid power engineering applied to the problems of human powered vehicles.

The main drawback of only using a fluid and no gears for power transfer in automobiles is the energy losses from heating the fluid at such high horsepower ratings. At less than three horsepower, this is not an issue. Realizing this fact was the first step in this development and the early design models resembled classic automotive forms having an impeller and spring-loaded moveable plate. In late April of 2001 the current configuration of bearings was used in design drawings for the first time.

The goal of the design has these three main criteria:

1. There is no shifting required by the rider on a variety of terrain and conditions, truly automatic operation.

2. Cost is approximately the same as the existing gearing it replaces.

3. The design can be made to fit any standard bicycle hub.

The consequence of these encourages a designer to choose fluids to change mechanical advantage in response to changes in torque instead of physically shifting a gear. The torque converter is able to do this and therefore the design problem was to create a torque converter mechanism which can fit a standard bicycle hub.

The springs are needed to allow the system to react to changes in torque close to instantaneously, using the properties of fluids to store any short-term energy and returning it to the system for a high overall efficiency. To give refined control of dynamic response, the spring shape can be altered to affect the bound vortex enclosed as well as the stiffness using common injection molding equipment and materials, this method is illustrated in the drawings.

### SUMMARY

Using a fluid for regulation of torque in the transmission of power for bicycles and other human powered vehicles in a way that changes mechanical advantage automatically for the rider. Similar in principle to automotive torque-converters, the design is unique in applying that concept to the bicycle, there is no prior art.

### BRIEF DESCRIPTION OF THE SEVERAL VIEWS OF THE DRAWING

The drawings render the Fluid Automatic Bicycle Transmission design for cassette freehubs, the freewheel model having a stepped Inner Shell and thus two sizes of Bearings as the major differences.

Plan View: Exterior Plan view showing the Cog A in foreground to receive drive chain, fluid chamber B of larger diameter in background and a depiction C of the freehub cassette lock-ring and freehub body inside the cog gear.

Cross-Section: Showing on the left side the cog gear A threaded to the outer shell B, wheel-side bearing D, spacer E, drive-side bearing D, inner shell C, lock-ring F, and freehub body G, Springs are not illustrated in this view.

Spring Plan View: A variety of spring configurations are possible, spring steel springs fastened to the outer shell would be rudimentary. The illustrated view is of an injection molded spring system A with highly elliptical vortex chambers B surrounding the inner shell and freehub body C.

### DETAILED DESCRIPTION OF THE INVENTION

A Fluid Automatic Bicycle Transmission comprised of a Cog, an Outer Shell with Springs, a Wheel-side Bearing, a Spacer, a Drive-side Bearing and an Inner Shell.

Said Inner Shell, formed and machined from stock to fit any freewheel or freehub body.

Power is transmitted by the chain to said Cog attached to said Outer Shell which imparts said Fluid with energy by accelerating it using drag as means within the device.

Said Inner Shell having said Wheel-side Bearing pressed onto it creating a fluid sealing means between said Wheel-side Bearing and said Inner Body.

Said Spacer press-fit onto said Inner Body abutting said Wheel-side Bearing. This Spacer is the surface in contact with the Fluid so is the Driven of the fluid system and can have drag increasing means such as slots or extended blades which can also act as Springs within the fluid system.

Said Outer Shell can be cut from seamless pipe stock and spun or formed into shape, or, machined from stock; with fluid filling means.

Springs. These can be strap steel attached to said Outer Shell or Spacer, injection molded plastic as illustrated. A design can use Springs attached to said the Outer Shell is ready for assembly.

Outer Shell is pressed onto Inner Shell creating fluid sealing means.

A Drive-side Bearing is pressed onto said Inner and Outer Shells creating the final sealing means for the fluid cavity between Inner and Outer Shell.

Said Fluid of appropriate viscosity and type is added and the filling means closed.

Said Cog is threaded onto said Outer Shell to complete assembly of said Fluid Automatic Bicycle Transmission.

1. A Fluid Automatic Bicycle Transmission means, also for other human powered vehicles, which changes mechanical advantage in response to changes in torque using a Fluid and Springs between Inner and Outer Shells incorporating Bearings with Fluid Filling and Sealing means.

2. Said Fluid Automatic Bicycle Transmission is simple and reasonable in cost to manufacture.

3. Said Fluid Automatic Bicycle Transmission can be made to fit any existing freewheel or freehub design.
